(19) United States
(12) Patent Application Publication
(10) Pub. No.: US 2016/0171993 A1
(43) Pub. Date: Jun. 16, 2016

(54) MAGNETIC HEAD WITH PLURAL READ ELEMENTS HAVING PINNED LAYERS MAGNETIC DISK DEVICE COMPRISING THE SAME AND READING METHOD USING MAGNETIC HEAD

(71) Applicant: Kabushiki Kaisha Toshiba, Tokyo (JP)

(72) Inventor: Tomokazu Okubo, Kawasaki Kanagawa (JP)

(21) Appl. No.: 14/639,081

(22) Filed: Mar. 4, 2015

(30) Foreign Application Priority Data
Dec. 10, 2014 (JP) 2014-250258

(51) Int. Cl. G11B 5/31; G11B 20/10

(52) U.S. Cl. CPC G11B 5/31; G11B 20/10046

(57) ABSTRACT

According to one embodiment, a magnetic head includes read elements each including a first magnetic layer having a pinned magnetization direction, and a second magnetic layer provided to oppose the first magnetic layer via an insulating layer therebetween and having a free magnetization direction. At least two of the read elements are arranged such that both of the first magnetic layer and the second magnetic layer of each of these elements cross an arbitrary line and the first magnetic layers of these elements are different in magnetization direction with respect each other.

### CROSS-REFERENCE TO RELATED APPLICATIONS

This application is based upon and claims the benefit of priority from Japanese Patent Application No. 2014-250258, filed Dec. 10, 2014, the entire contents of which are incorporated herein by reference.

### FIELD

Embodiments described herein relate generally to a magnetic head comprising a read element, a magnetic disk device comprising the magnetic head and a reading method using the magnetic head.

### BACKGROUND

As a data recording device, for example, a magnetic disk device comprises a disk-shaped recording medium, that is, a magnetic disk, disposed in a case, and a magnetic head configured to read/write data from/on the magnetic disk.

Recently, for the improvement of recording density, shingled magnetic recording has been proposed as a technique for recording data on a magnetic disk. The shingled magnetic recording is a recording technique in which write data are overwritten in a track width direction of the magnetic disk, and is a technique which enable designing of a high track density (TPI) even when a wide magnetic head (write head) is employed.

Because of the shape of a main pole of the magnetic head (write head), the magnetic field distribution in the vicinity of the edge of the main pole is not perpendicular in a down-track direction, but curved. As a result, the recording pattern is curved according to the magnetic field distribution. Particularly, in the case of the shingled magnetic recording, a recording pattern portion which remains to be written as data by overwriting is limited substantially to the curved area. Therefore, the reading of the recording data is directly affected by the curvature of the recording pattern. Meanwhile, in shingled magnetic recording, the overwriting direction is sometimes reversed at a skew angle of zero in order to secure the magnetic field gradient. In this case, the reading output sensitivity becomes uneven between an inner circumferential portion and an outer circumferential portion of the recording medium.

### BRIEF DESCRIPTION OF THE DRAWINGS

FIG. 1 is a block diagram schematically showing a hard disk drive (HDD) of a first embodiment;

FIG. 2 is a side view showing a magnetic head, a suspension and a magnetic disk in the HDD;

FIG. 3 is an enlarged plan view schematically showing a head portion of the magnetic head;

FIG. 4 is a block diagram schematically showing a positional relationship between a recording pattern of shingled magnetic recording onto a magnetic disk and a read element;

FIG. 5 is a block diagram showing an example of an equalization circuit of the HDD;

FIG. 6 is a block diagram showing an equalization circuit of a modified example;

FIG. 7 is a plan view schematically showing a position of the magnetic head with respect to the magnetic disk of the HDD of the first embodiment;

FIG. 8 is a diagram schematically showing positional relationships between the read head of the HDD and a data track for various skew angles as compared with each other;

FIG. 9 is a flowchart showing an adjusting operation for averaging weight coefficient in the HDD; and

FIG. 10 is a flowchart showing a data reading (read) operation in the HDD.

### DETAILED DESCRIPTION

Various embodiments will be described hereinafter with reference to the accompanying drawings. In general, according to one embodiment, magnetic head comprises a plurality of read elements each comprising a first magnetic layer having a pinned magnetization direction, and a second magnetic layer provided to oppose the first magnetic layer via an insulating layer therebetween and having a free magnetization direction, wherein at least two of the plurality of read elements are arranged such that both of the first magnetic layer and the second magnetic layer of each of the at least two read elements cross an arbitrary line and the first magnetic layers of the at least two read elements are different in magnetization direction with respect each other.

A hard disk drive (HDD) of an embodiment as a disk device will now be described in detail.

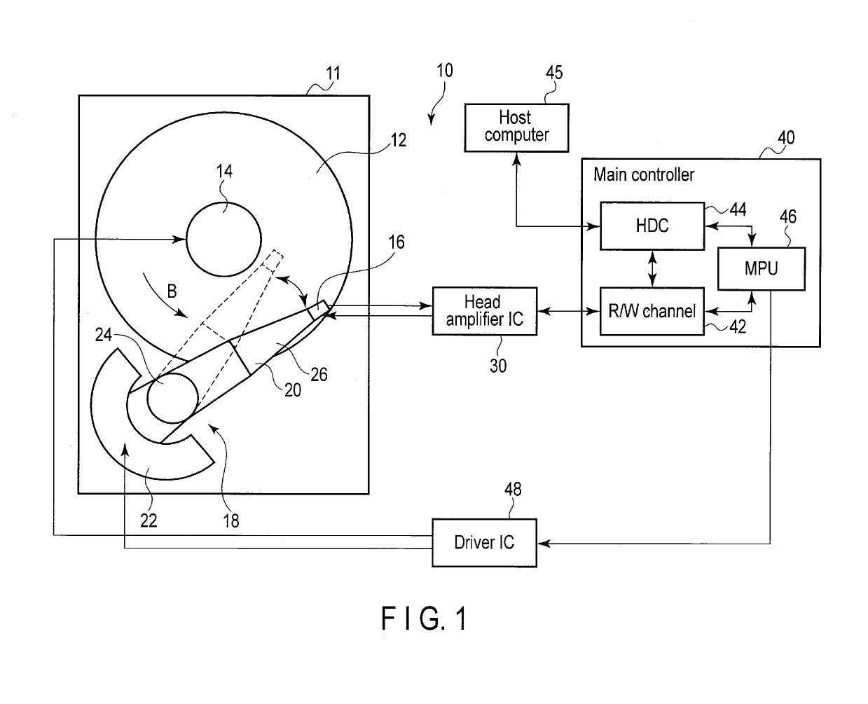

FIG. 1 is a block diagram schematically showing an HDD of a first embodiment, and FIG. 2 is a side view showing a magnetic head in a flying state and a magnetic disk.

As shown in FIG. 1, an HDD 10 comprises a rectangular housing 11, a magnetic disks 12 accommodated as recording media in the housing 11, a spindle motor 14 supporting and rotating the magnetic disk 12, and a plurality of magnetic heads 16 configured to write/read data on/from the magnetic disk 12. The HDD 10 comprises a head actuator 18 configured to move each magnetic head 16 to above an arbitrary track on the magnetic disk 12 for positioning. The head actuator 18 comprises a suspension assembly 20 configured to movably support the magnetic heads 16 and a voice coil motor (VCM) 22 configured to rotate the suspension assembly 20.

The HDD 10 comprises a head amplifier IC 30, a main controller 40 and a driver IC 48. The head amplifier IC 30 is provided on, for example, the suspension assembly 20 and is electrically connected to the magnetic head 16. The main controller 40 and driver IC 48 are each constituted by a control circuit board (not shown) provided in a rear surface side of the housing 11. The main controller 40 comprises an R/W channel 42, a hard disk controller (HDC) 44 and a microprocessor (MPU) 46. The main controller 40 is electrically connected to the magnetic heads 16 via the head amplifier IC 30. The main controller 40 is electrically connected also to the VCM 22 and spindle motor 14 via the driver IC 48. The HDC 44 is connectable to a host computer 45.

As shown in FIGS. 1 and 2, the magnetic disk 12 is a perpendicular magnetic medium. The magnetic disk 12 comprises a substrate 101 formed of a nonmagnetic substance and in the shape of a disc having a diameter of approximately 2.5 inches (6.35 cm), for example. On both surfaces of the substrate 101, soft magnetic layers 102 as underlying layers, magnetic recording layers 103 and protection film layers 104 as upper layers, are stacked in this order. The magnetic disk 12 is coaxially fit a hub of the spindle motor 14, and is rotated in a direction indicated by arrow B by the spindle motor 14 at a predetermined speed.

The suspension assembly 20 comprises a bearing unit 24 rotatably fixed to the housing 11 and a plurality of suspensions 26 extending from the bearing unit 24. As shown in FIG. 2, each magnetic head 16 is supported on an extending end of each respective suspension 26. Each magnetic head 16 is electrically connected to the head amplifier IC 30 via an interconnect (wiring) member 28 provided on the suspension assembly 20.

As shown in FIG. 2, each of the magnetic heads 16 is formed as a flying head, and comprises a slider 15 formed in a substantially rectangular parallelepiped shape, and a head section 17 formed in an outflow end (trailing) side of the slider 15. The slider 15 is formed of, for example, a sintered body of alumina and titanium carbide (that is, AlTiC), and the head section 17 comprises a plurality of thin films.

The slider 15 comprises a disk-facing surface (medium-facing surface or air bearing surface [ABS]) 13 opposing the surface of the magnetic disk 12. The slider 15 is caused to fly above the surface of the magnetic disk by a predetermined amount by airflow C which is produced between the surface of the magnetic disk 16 and the ABS 13 by the rotation of the magnetic disk 12. The direction of airflow C is coincident with the direction of rotation of the magnetic disk 12. The slider 15 comprises a leading end 15a located on an inflow side of airflow C, and a trailing end 15b located on an outflow side of airflow C.

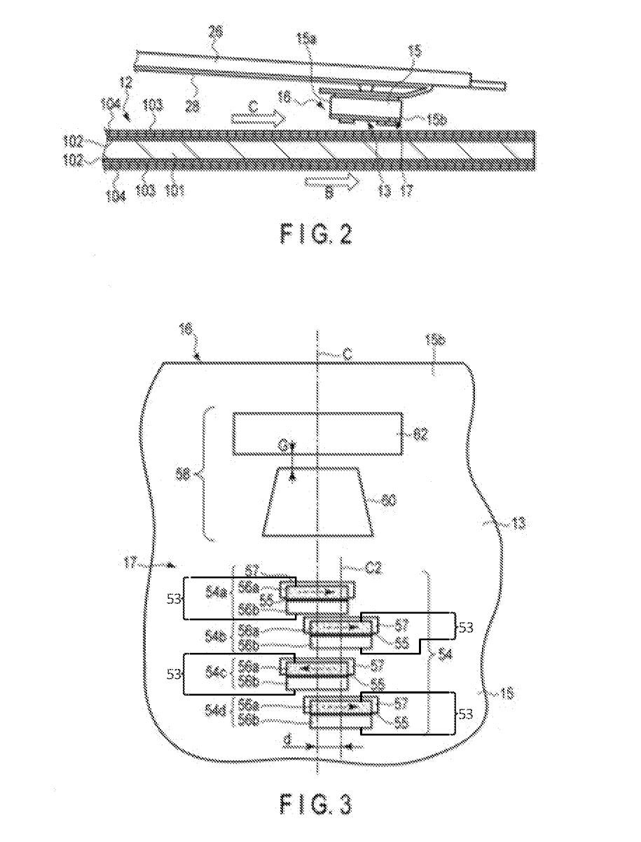

FIG. 3 is an enlarged plan view schematically showing the head section of the magnetic head as viewed from the ABS side. The head section 17 of the magnetic head 16 comprises a read head 54 and recording head 58 formed in the trailing end 15b of the slider 15 by a thin-film process, and thus the magnetic head 16 is of a separation type.

The recording head 58 is provided on the side of the trailing end 15b of the slider 15 with respect to the read head 54. The recording head 58 comprises a main pole 60 of a material having high magnetic permeability, configured to produce a magnetic field for recording, perpendicular to the ABS 13, a write shield 62 opposing the main pole 60 via a write gap G, a recording coil (not shown) wound around a magnetic core consisting of the main pole 60 and the write shield 62, etc. The main pole 60 and the write shield 62 are aligned on a longitudinal axis (central axis C) of the slider 15. Distal ends of the main pole 60 and the write shield 62 are exposed to the ABS 13.

The read head 54 comprises a plurality of read elements prepared on the assumption of the two-dimensional magnetic recording (TDMR). In this embodiment, the read head 54 comprises four elements, that is, first to fourth read elements 54a, 54b, 54c and 54d. Each read element employs a tunnel junction (tunneling magnetoresistive [TMR]) element. More specifically, each of the read elements 54a, 54b, 54c and 54d comprises a magnetic pinned layer (first magnetic layer) 56a and a magnetic free layer (second magnetic layer) 56b stacked via an insulating layer 55. Pinned layer 56a and free layer 56b are each formed of a magnetic material. Pinned layer 56a has a direction of magnetization pinned in a certain direction by magnetic filed from a hard bias layer 57. Magnetization of free layer 56b is not completely pinned, but the direction of the magnetization varies depending on external magnetic field (leakage field from a recording medium, that is, the magnetic disk 12). An electrode or electrode film (not shown) is provided to be in contact with the pinned layer 56a and free layer 56b.

The TMR read element is configured to convert a change in angle made between the magnetization of the pinned layer 56a and that of the free layer 56b into a reading signal to be output. For example, when the direction of the magnetization of the pinned layer 56a is the same as that of the free layer 56b, the electrical resistance of the read element is low, whereas they differ in the direction of magnetization, the resistance is high. By utilizing this mechanism, the TMR read element reads signal corresponding to a magnetic field for recording, from the magnetic disk 12.

The first to fourth read elements 54a, 54b, 54c and 54d are arranged in such a manner that the longitudinal direction of each element normally crosses the central axis (first axis) C of the slider 15, and also the elements are aligned at predetermined intervals therebetween in the axial direction of the central axis C. In other words, the first to fourth read elements 54a, 54b, 54c and 54d are disposed in parallel with each other. The distal ends (lower ends) of the first to four read elements 54a, 54b, 54c and 54d are exposed to the ABS 13.

Of the four read elements, first read element 54a and third read element 54c are disposed so that the longitudinal centers thereof are aligned on the central axis C. The rest, second read element 54b and fourth read element 54d are disposed so that the longitudinal centers thereof are aligned on a second central axis (second axis) C. The second central axis C2 is in parallel with the central axis C of the slider 15 and away by a predetermined distance d from the central axis C. In other words, the second and forth read elements 54b and 54d are arranged so that they are displaced by a distance d in a direction perpendicular to the central axis C with respect to the first and third read elements 54a and 54c.

As will be described later, in the HDD 10, two read elements selected from the four read elements 54a, 54b, 54c and 54d carry out data reading according to the position of the magnetic head 16 in the radial direction of the magnetic disk 12 or the skew angle of the magnetic head 16 with respect to the data track. In the selected two read elements, the magnetizations of the pinned layers 56a of these elements are antiparallel to each other, that is, in opposite directions with respect to each other. In this embodiment, as shown in FIG. 3, the magnetization of the pinned layer 56a of each of the first, second, and fourth read elements 54a, 54b and 54c is set in the rightward direction, whereas that of the pinned layer 56a of the third read element 54c is set in the leftward direction (reverse direction).

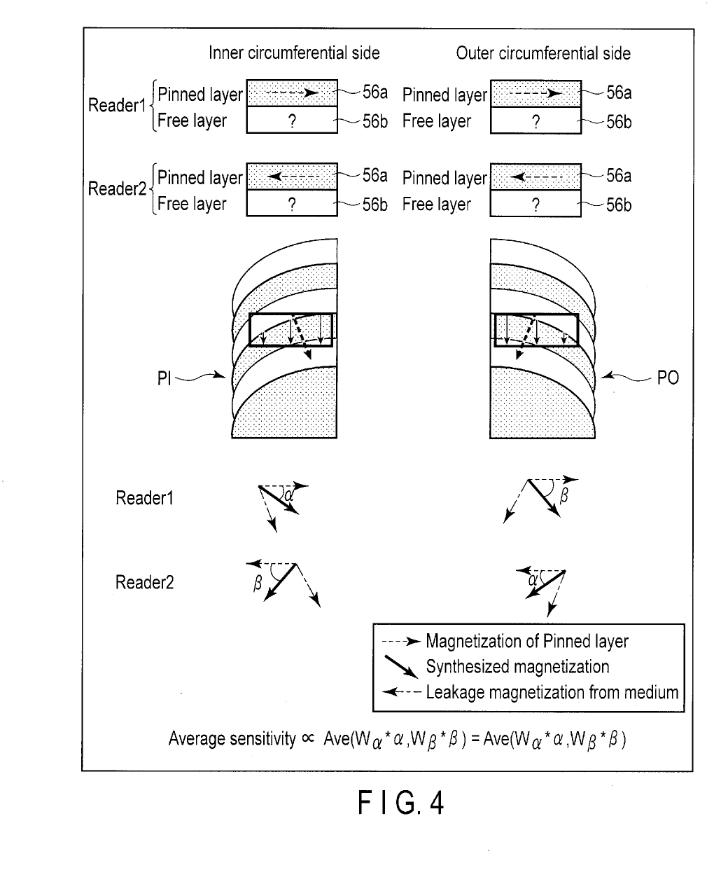

The HDD 10 is configured to record write data by the shingled magnetic recording on the recording layer of the magnetic disk 12 using the magnetic head 16 configured as described above. That is, write data is overwritten in a cross-track direction, and thus a high TPI is obtained. FIG. 4 schematically shows recording patterns on data tracks recorded by shingled magnetic recording on outer and inner circumferential sides of the magnetic disk 12. As shown in this figure, in the case of the shingled magnetic recording, the recording pattern remaining on the data track includes a recording pattern PO recorded on the outer circumferential side of the magnetic disk 12, and a recording pattern PI recorded on the inner circumferential side thereof, both of which are curved. In the shingled magnetic recording, the overwriting directions in the inner and outer circumferential sides of the magnetic disk 12 are reversed with respect to the radial central portion of the magnetic disk (that is, the region where the skew angle of the recording head 16 becomes zero) in order as to suppress the variation in recording quality due to skew angle of the magnetic head 16. As a result, the curving directions of the recording patterns PO and PI are reversed. That is, leakage magnetic fields from the magnetic disk 12 are inclined in reverse directions between the inner and outer circumferential sides of the magnetic disk 12. Therefore, the relative angles of magnetizations inside pinned layer 56a and free layer 56b of each read element do not coincide between when the read element is located in the inner circumferential side portion of the magnetic disk 12 and when it is located in the outer circumferential side portion thereof.

Let us suppose that the selected two read elements described above are referred to as reader 1 and reader 2. Here, as shown in FIG. 4, the readers 1 and 2 have the directions of magnetization of their pinned layers 56a reversed with respect to each other. FIG. 4 illustrates only the magnetization of pinned layer 56a on the assumption that the direction of magnetization of pinned layer 56a is the same as that of a hard bias layer. Let us now suppose the case where the recording patterns PO and PI are read with the two readers 1 and 2 which differ from each other in the magnetization direction of the pinned layer 56a. Here, in each single reader, the relative angles of magnetization of pinned layer 56a and free layer 56b are directed in reverse between the inner circumferential side and the outer circumferential side portion of the magnetic disk 12. More specifically, for example, when the relative angles of magnetization of each reader in the inner circumferential side of the magnetic disk 12 are expressed as: (reader 1, reader 2)=(α, β), the relative angles of magnetization of each reader in the outer circumferential side of the magnetic disk 12 are expressed as: (reader 1, reader 2)=(α, β). With this configuration, the averages of the relative angles of readers 1 and 2 in the inner and outer circumferential sides of the magnetic disk 12 coincide with each other. Therefore, the reading waveform of reader 1 and that of reader 2 are weight-averaged by means of circuit, and thus the influence of the inclination of the medium magnetization caused by curvature of the recording pattern can be canceled.

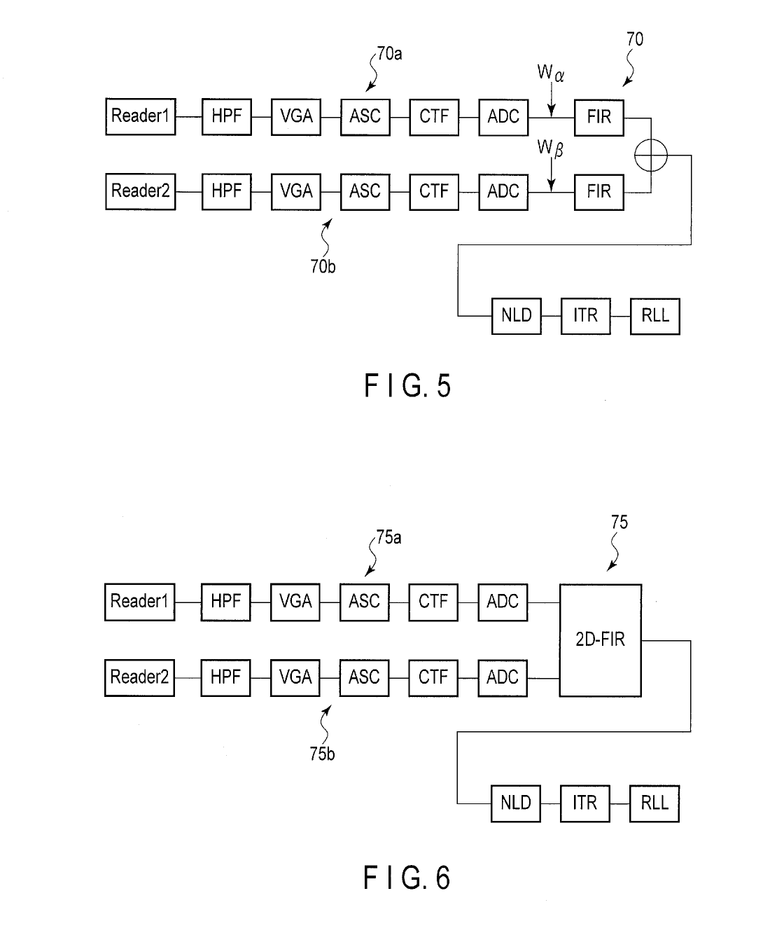

FIG. 5 shows an equalization circuit which averages reading waveforms from the readers 1 and 2. An equalization circuit 70 is provided in the R/W channel 42 and comprises a first series 70a for the reader 1 and a second series 70b for the reader 2. Each of the series 70a and 70b comprises a high-pass filter (HPF), a variable gain amplifier (VGA), an asymmetry correction circuit (ASC), a continuous time filter (CTF), an AD converter (ADC), and a finite impulse response circuit (FIR). Outputs from FIR filters (FIR) of the two series are synthesized and the synthesized signal is output to the HDC 44 via a non-linear distortion adjusting circuit (NLD) and an error correction circuit (ITR, RLL).

In the first and second series 70a and 70b, weighting coefficients W_{α} and W_{β} are added to respective reading signals for averaging between the ADC and FIR. By optimizing weighting coefficients W_{α} and W_{β}, non-uniformity in reading output sensitivity among zones, which is due to curvature of recording patterns, can be canceled.

FIG. 5 shows the equalization circuit 70 configured to simply averaging the reading waveforms of the first and second series 70a and 70b as an example, but a similar effect can be obtained by using a TDMR circuit. For example, as shown in FIG. 6, a TDMR equalization circuit 75 uses a two-dimensional finite impulse response circuit (2D-FIR: two-dimensional equalizer) which equalizes first series 75a and second series 75b simultaneously. In this case, averaging is automatically included as part of the equalization process, and weighting coefficients W_{α} and W_{β} are reflected in the tap coefficient of the two-dimensional equalizer (2D-FIR).

With use of either one of equalization circuits 70 and 75, each of the reading signals of two read elements, that is, the readers 1 and 2, is constituted by a reading signal of relative angle α (low reading sensitivity) and that of relative angle β (high reading sensitivity). With this configuration, the reading sensitivity of the read head obtained as a result here is an average of these relative angles, which is constant regardless of the inner or outer circumferential side of the magnetic disk 12.

However, there are still non-uniformity in magnetization between two pinned layers 56a and dispersion in leakage magnetic field from recording patterns. Under these circumstances, such a case is considered that the magnetization pinning direction of the pinned layer 56a, which optimizes the bit error rate (BER) of reading signal is biased to one direction. Here, with the magnetic head 16 of this embodiment, average-weighting coefficients W_{α} and W_{β} shown in FIG. 5 can be arbitrarily set. Meanwhile, in the case of TDMR shown in FIG. 6, it is general that the tap coefficient of the 2D-FIR (weighting coefficients W_{α} and W_{β}) is subjected to optimization sequentially by adaptation. Therefore, in the magnetic head 16, the influence of the curvature of recording patterns can be canceled always under the optimal BER conditions.

The cancelling effect for non-uniformity in reading sensitivity by the averaging is maximum when the longitudinal centers of the two read elements are aligned with a center of the data track in its width direction, that is, when the offset of the two read elements in the cross-track direction in reading is zero. However, with this embodiment, even if the offset is not zero, the above-described cancelling effect can be optimized by setting the average-weighting coefficient appropriately.

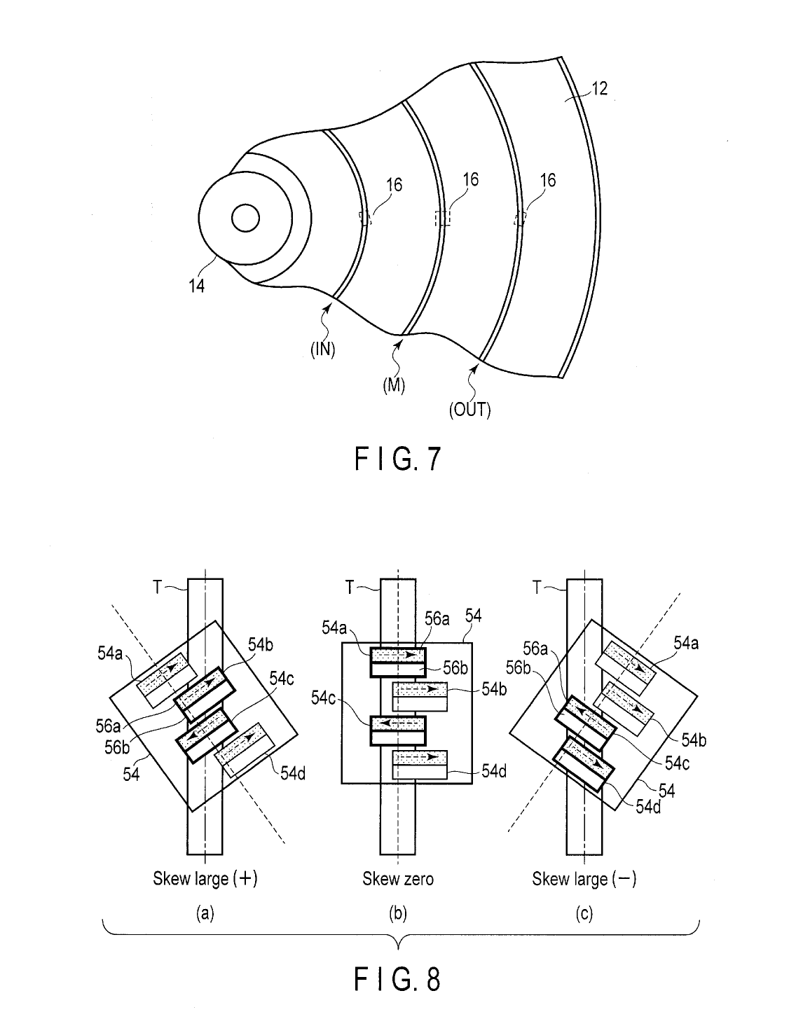

As shown in FIGS. 7 and 8, the position of each read element varies (offset) according to the radial position of the magnetic head 16 with respect to the magnetic disk 12, that is, the skew angle of the magnetic head 16 with respect to a data track T. For example, when the magnetic head 16 is located at an inner circumferential side (IN), a medium portion (M) or an outer circumferential side (OUT), the skew angle of the magnetic head 16 is large (+), zero, and large (−), respectively. The read head 54 of this embodiment has such an arrangement structure that two read elements overlap about a data track T to be read at each of skew angles of large (+), zero and large (−). Also, the first to fourth read elements 54a, 54b, 54c and 54d are arranged so that the directions of magnetization of pinned layers 56a of the two overlapping read elements are reversed with respect to each other.

As shown in FIG. 8, from the four read elements 54a, 54b, 54c and 54d, two read elements locating on the central axis of the data track T are selected to read data. For example, when the magnetic head 16 is located on the inner circumferential side (IN) of the magnetic disk 12, second read element 54b and third read element 54c (indicated by bold frame), whose centers are located on the central axis of the data track T, are selected. When the magnetic head 16 is located on the middle portion (M) of the magnetic disk 12, first read element 54a and third read element 54c (indicated by bold frame), whose centers are located on the central axis of the data track T, are selected. When the magnetic head 16 is located on the outer circumferential side (OUT) of the magnetic disk 12, third read element 54c and fourth read element 54d (indicated by bold frame), whose centers are located on the central axis of the data track T, are selected.

As described above, in actual signal reading, the signals are processed while activating only two read elements located on the central axis of the data track T according to the skew angle of the magnetic head 16. In this manner, the above-described canceling effect of non-uniformity of reading sensitivity can be maximized even if a skew angle is created.

The structure of the read elements is not limited to the above-described arrangement that they are disposed at predetermined offsets. It is alternatively possible to employ such a head actuator structure that the skew angle becomes zero at any radial position (for example, a linear actuator which can move a magnetic head linearly in the radial direction of a magnetic disk).

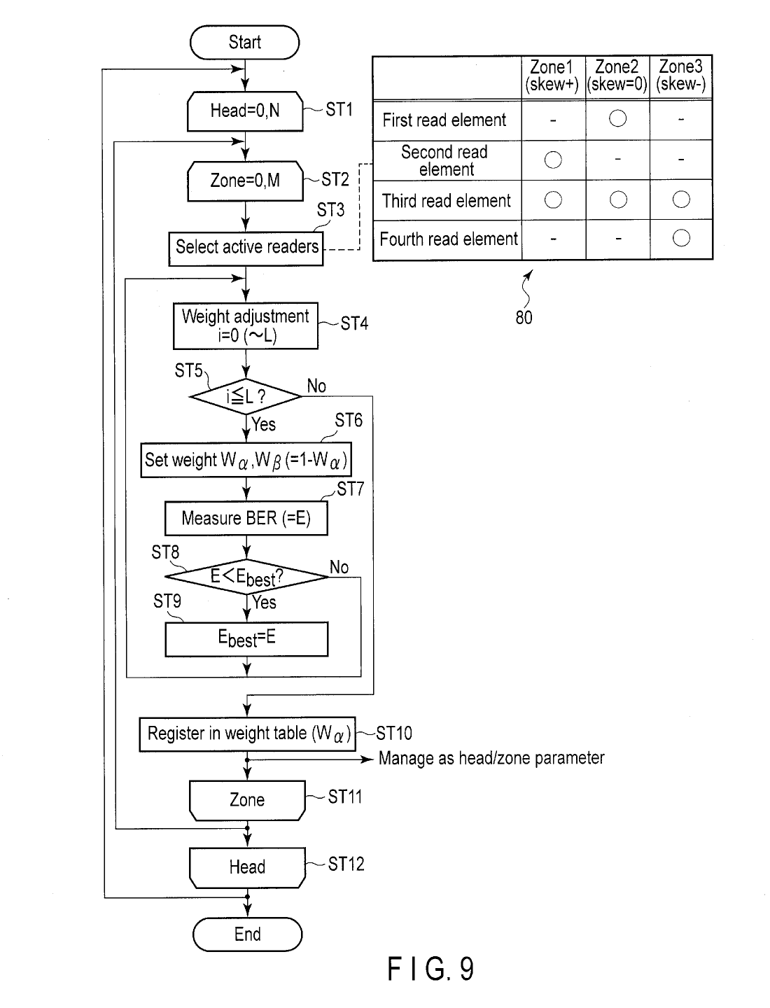

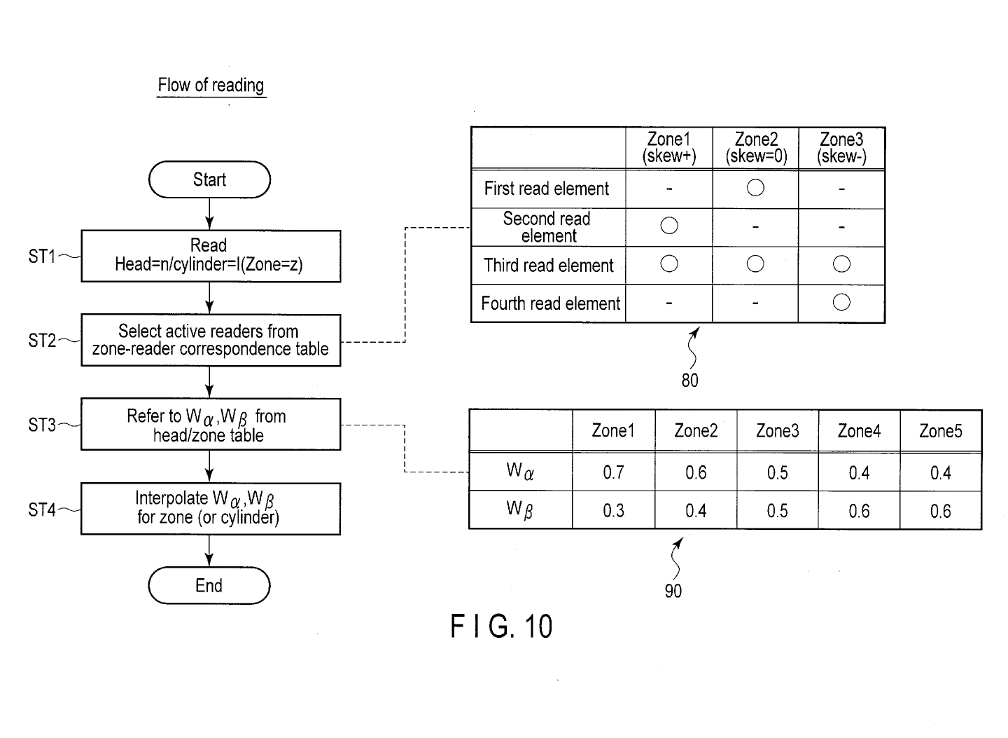

FIG. 9 is a flowchart illustrating an initial adjustment for average-weighting coefficients W_{α} and W_{β} (formation of weighting coefficient table), and FIG. 10 is a flowchart illustrating reading of recording data.

As shown in FIG. 9, the MPU 46 comprises a selection (zone/reader) table 80 configured to select read elements according to the radial position of the magnetic head 16. Based on the selection table 80, two read elements which are to be used respectively in the inner circumferential side (zone 1), the middle portion (zone 2) or the outer circumferential side (zone 3), for example, are determined out of first to fourth read elements 54a, 54b, 54c and 54d.

The MPU 46 first specifies one of the magnetic heads 16 (ST1), and specifies one of the zones (1 to M) of the magnetic disk 12 (ST2). Subsequently, the MPU 46 selects two read elements (active readers) based on the selected zone and the selection table 80 (ST3), and further carries out weighting adjustment on the active readers (L times at maximum) (ST4). When the number of times of the weighting adjustment, here, referred to as i, is less than or equal to L (ST5), the MPU 46 sets average-weighting coefficients W_{α} and W_{β} (ST6).

Next, the MPU 46 averages the reading signals using the set average-weighting coefficients W_{α} and W_{β} to measure BER (E) of the reading signals (ST7). Then, the MPU 46 compares the measured BER (E) and the optimal value (Ebest) with each other (ST8). Here, when the measured BER (E) is less than the optimal value (Ebest), the MPU 46 sets the measured BER (E) as the optimal value (Ebest) (ST9) and then returns the step to ST4. When the measured BER (E) is greater than or equal to the optimal value (Ebest) in ST8, the step is returned to ST4. The MPU 46, in ST5, finishes the search for the optical values for the weighting coefficients when the number of weighting adjustments i just becomes greater than L, and then registers the average-weighting coefficients W_{α} and W_{β} of that time to the memory (ST10). Further, the MPU 46 registers the zones and magnetic heads (ST11 and ST12), and manages the registered data as head/zone parameter data.

Thus, the MPU 46 forms a (head/zone) table 90 for average-weighting coefficients W_{α} and W_{β} corresponding to the magnetic heads, read elements and zones of the magnetic disk f (see FIG. 10). The table 90 shown here is an example in which weighting coefficients are managed by table while thinning zones on the magnetic disk 12 (that is, for example, the entire zone of the magnetic disk is divided into five (zones 1 to 5). When the capacity of the memory is sufficient, the weighting coefficient table may be formed for all zones on the magnetic disk 12.

As shown in FIG. 10, when reading recording data, the MPU 46 specifies a magnetic head 16 (n) used for reading, a cylinder (zone) of the magnetic disk 12 (ST1), and then selects two read elements (active readers) from the selection table (ST2). Subsequently, the MPU 46 refers to weighting coefficients W_{α} and W_{β} corresponding to the elements from the (head/zone) table 90. Then, with the selected two read elements (active readers), recording data are read from the magnetic disk 12 and the reading signals are amplified by the head amplifier IC. The amplified reading signals are input to the equalization circuit 70 of the R/W channel 42. Further, the MPU 46 interpolates the weighting coefficients W_{α} and W_{β} referred to, by adding these to the reading signals of the two read elements (ST4). Thus, the reading waveforms from the two read elements are averaged, and thereafter, the reading signals are sent to the HDC 44 via the non-linear distortion adjusting circuit (NLD) and the error correction circuit (ITR, RLL).

According to the HDD with the above-described structure and the shingled magnetic recording method for recording data on the magnetic disk, a high track density (TPI) can be achieved even if a wide magnetic head (write head) is used. Even if recording patterns are curved by shingled recording, recording data are read by two read elements the directions of magnetization whose pinned layers are reversed and thus averaged. In this manner, the influence of inclination of magnetization of the medium, caused by curvature of the recording patterns, can be canceled out. Therefore, deterioration in the S/N ratio of reading signals can be suppressed, thereby making it possible to improve the quality of the reading signals.

In addition, the weighting coefficients W_{α} and W_{β} added to reading waveforms are optimized, and thus non-uniformity in reading output sensitivity among zones, which is caused by pinned layers of read elements, can be further reliably canceled. Moreover, only two read elements located on the central axis of a data track T are selected as active according to a reading area (zone) of the magnetic disk or the skew angle of the magnetic head, to read signals. In this manner, the effect of canceling non-uniformity in reading sensitivity can be maximized even if a skew angle is created.

With the above-described structures, a magnetic head with an improved quality in reading signal and a disk device with this head can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the number of read elements of each read head is not limited to four, but may be two, three or five ore more. The arrangement of a plurality of read elements is not limited to those discussed in the above-provided embodiments unless the centers of at least two read elements can be aligned along the central axis of a data track. Further, the determination of average-weighting coefficients W_{α} and W_{β} is not limited to by referring to a (head/zone) table, but they may be determined based on results of measurement of reading characteristics of each read element by default in advance.

1. A magnetic head comprising:
a plurality of read elements each comprising a first magnetic layer having a pinned magnetization direction, a second magnetic layer opposing the first magnetic layer via an insulating layer therebetween and having a free magnetization direction, and an independent electrode in contact with the first and second magnetic layers to output a reading signal from each read element;
wherein at least two of the plurality of read elements are arranged such that both of the first magnetic layer and the second magnetic layer of each of the at least two read elements cross an arbitrary line and the first magnetic layers of the at least two read elements are different in magnetization direction with respect each other.

2. The magnetic head of claim 1, wherein
the at least two read elements are arranged such that the magnetization directions thereof are in parallel and opposite to each other.

3. The magnetic head of claim 1, wherein
the plurality of read elements are arranged such that centers of at least two of the plurality of read elements are aligned on the arbitrary line and the first magnetic layers of the at least two read elements are different in magnetization direction with respect each other.

4. The magnetic head of claim 1, wherein
the plurality of read elements comprise a first read element and a third read element arranged such that centers thereof are located on a first axis, and a second read element and a fourth read element arranged such that centers thereof are located on a second axis extending in parallel with the first axis and away by a predetermined distance from the first axis, and the first, second, third and fourth read elements are aligned in a direction of the first axis at predetermined intervals.

5. The magnetic head of claim 4, wherein
the first, second and fourth read elements comprise pinned layers magnetized in a same direction, and the third read element comprises a pinned layer magnetized in a direction opposite to that of the pinned layer of the first read element.

6. A magnetic disk device comprising:
a disk shaped recording medium; and
the magnetic head of claim 1, configured to read data of the recording medium.

7. The magnetic disk device of claim 6, further comprising: an equalization circuit configured to average reading signals of two series read by the at least two read element of the magnetic head based on respective weighting coefficients and to synthesize the signals.

8. The magnetic disk device of claim 7, further comprising: a controller configured to set the weighting coefficients according to a reading zone of the recording medium and a read element employed.

9. The magnetic disk device of claim 6, further comprising: a controller configured to select, according to a skew angle of the magnetic head with respect to a data track of the recording medium, two read elements located on a central axis of the data track from the plurality of read elements.

10. The magnetic disk device of claim 6, wherein the at least two read elements are arranged such that the magnetization directions thereof are in parallel and opposite to each other.

11. The magnetic disk device of claim 6, wherein the plurality of read elements are arranged such that centers of at least two of the plurality of read elements are aligned on the arbitrary line and the first magnetic layers of the at least two read elements are different in magnetization direction with respect each other.

12. The magnetic disk device of claim 6, wherein the plurality of read elements comprise a first read element and a third read element arranged such that centers thereof are located on a first axis, and a second read element and a fourth read element arranged such that centers thereof are located on a second axis extending in parallel with the first axis and away by a predetermined distance from the first axis, and the first, second, third and fourth read elements are aligned in a direction of the first axis at predetermined intervals.

13. The magnetic disk device of claim 12, wherein the first, second and fourth read elements comprise pinned layers magnetized in a same direction, and the third read element comprises a pinned layer magnetized in a direction opposite to that of the pinned layer of the first read element.

14. A reading method of reading recording data recorded on a recording medium, using a magnetic head comprising a plurality of read elements each comprising a first magnetic layer having a pinned magnetization direction, a second magnetic layer provided to oppose the first magnetic layer via an insulating layer there between and having a free magnetization direction, and an independent electrode in contact with the first and second magnetic layers to output a reading signal from each read element, wherein at least two of the plurality of read elements are arranged such that both of the first magnetic layer and the second magnetic layer of each of the at least two read elements cross an arbitrary line and the first magnetic layers of the at least two read elements are different in magnetization direction with respect each other, the method comprising:
selecting, according to a skew angle of the magnetic head with respect to a data track of the recording medium, two read elements located on a central axis of the data track from the plurality of read elements;
reading recording data on the data track by the selected two read elements; and
averaging and synthesizing reading signals of two series read by the two read elements based on respective weighting coefficients.

15. The method of claim 14, further comprising: setting the weighting coefficients according to a reading zone of the recording medium and a read element employed.

16. The magnetic head of claim 1, wherein each of the plurality of read elements comprises an independent hard bias layer opposed to the first magnetic layer.
